(19) United States
(12) Patent Application Publication
(10) Pub. No.: US 2026/0230467 A1
(43) Pub. Date: Aug. 6, 2026

(54) SYSTEM AND METHOD FOR AUTOMATICALLY SELECTING AUTHENTICATION TOKENS TO AUTHENTICATE USERS BASED ON DYNAMICALLY COMPUTED REAL-TIME EXPOSURE METRICS

(71) Applicant: BANK OF AMERICA CORPORATION, Charlotte, NC (US)

(72) Inventors: Kristian Rascon, Plano, TX (US); Karen F. Calderone, Troutman, NC (US); Kalyan V. Pasumarthi, Frisco, TX (US); Sakuntala Devi Sagiraju, Frisco, TX (US); James B. Stone, Aubrey, TX (US)

(73) Assignee: BANK OF AMERICA CORPORATION, Charlotte, NC (US)

(21) Appl. No.: 19/043,035

(22) Filed: Jan. 31, 2025

(51) Int. Cl. H04L 9/40

(52) U.S. Cl. CPC H04L 63/083

(57) ABSTRACT

Embodiments of the present invention provide a system for automatically selecting authentication tokens to authenticate users based on dynamically computed real-time exposure metrics. The system is configured to receive a communication request from a user, via a communication channel of a plurality of communication channels associated with an entity, analyze the communication request to identify one or more parameters associated with the communication request, retrieve a plurality of authentication tokens that are associated with the user, transmit the one or more parameters and the plurality of authentication tokens to a neural network model, determine, via the neural network model, a first authentication token of the plurality of authentication tokens to authenticate the user for processing the communication request, and authenticate the user, via the first authentication token, for processing the communication request.

### BACKGROUND

There exists a need for a system that can efficiently and accurately authenticate one or more users associated with an entity.

### BRIEF SUMMARY

The following presents a summary of certain embodiments of the invention. This summary is not intended to identify key or critical elements of all embodiments nor delineate the scope of any or all embodiments. Its sole purpose is to present certain concepts and elements of one or more embodiments in a summary form as a prelude to the more detailed description that follows.

Embodiments of the present invention address the above needs and/or achieve other advantages by providing apparatuses (e.g., a system, computer program product and/or other devices) and methods for automatically selecting authentication tokens to authenticate users based on dynamically computed real-time exposure metrics. The system embodiments may comprise one or more memory devices having computer readable program code stored thereon, a communication device, and one or more processing devices operatively coupled to the one or more memory devices, wherein the one or more processing devices are configured to execute the computer readable program code to carry out the invention. In computer program product embodiments of the invention, the computer program product comprises at least one non-transitory computer readable medium comprising computer readable instructions for carrying out the invention. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the invention.

In some embodiments, the present invention receives a communication request from a user, via a communication channel of a plurality of communication channels associated with an entity, analyzes the communication request to identify one or more parameters associated with the communication request, retrieves a plurality of authentication tokens that are associated with the user, transmits the one or more parameters and the plurality of authentication tokens to a neural network model, determines, via the neural network model, a first authentication token of the plurality of authentication tokens to authenticate the user for processing the communication request, and authenticates the user, via the first authentication token, for processing the communication request.

In some embodiments, the present invention determines that authentication of the user via the first authentication token is successful and processes the communication request.

In some embodiments, the present invention determines that authentication of the user via the first authentication token is not successful and routes the communication request to an associate of the entity.

In some embodiments, the present invention calculates an authentication score after authenticating the user via the first authentication token, determines that the authentication score does not meet a predefined threshold, and continues authenticating the user via the plurality of authentication tokens excluding the first authentication token until the authentication score of the user reaches a predefined threshold.

In some embodiments, the present invention continues authenticating the user until the authentication score of the user reaches the predefined threshold based on determining, via the neural network model, a second authentication token of the plurality of authentication tokens; and authenticating the user via the second authentication token.

In some embodiments, the present invention trains the neural network model based on historical communication data between one or more users and one or more associates associated with the entity.

In some embodiments, the communication channel is a voice communication channel.

In some embodiments, the present invention converts voice input received from the user to text input, via one or more natural language processing models for determining the one or more parameters associated with the communication request.

In some embodiments, the present invention determines the plurality of authentication tokens for authenticating the user based on one or more rules.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 provides a block diagram illustrating a system environment for automatically selecting authentication tokens to authenticate users based on dynamically computed real-time exposure metrics, in accordance with an embodiment of the invention;

FIG. 2 provides a block diagram illustrating the entity system 200 of FIG. 1, in accordance with an embodiment of the invention;

FIG. 3 provides a block diagram illustrating an authentication token selection and execution system 300 of FIG. 1, in accordance with an embodiment of the invention;

FIG. 4 provides a block diagram illustrating the computing device system 400 of FIG. 1, in accordance with an embodiment of the invention;

FIG. 5 provides a process flow for automatically selecting authentication tokens to authenticate users based on dynamically computed real-time exposure metrics, in accordance with an embodiment of the invention; and

FIG. 6 provides a block diagram illustrating the process of automatically selecting authentication tokens to authenticate users based on dynamically computed real-time exposure metrics, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As described herein, the term “entity” may be any organization that utilizes one or more authentication methods for authenticating users communicating via one or more channels. In some embodiments, the entity may be a financial institution which may include herein may include any financial institutions such as commercial banks, thrifts, federal and state savings banks, savings and loan associations, credit unions, investment companies, insurance companies and the like. In some embodiments, the entity may be a non-financial institution. As described herein, a “user” may be an employee, a customer, or a potential customer of the entity.

Many of the example embodiments and implementations described herein contemplate interactions engaged in by a user with a computing device and/or one or more communication devices and/or secondary communication devices. Furthermore, as used herein, the term “user computing device” or “mobile device” may refer to mobile phones, computing devices, tablet computers, wearable devices, smart devices and/or any portable electronic device capable of receiving and/or storing data therein.

A “user interface” is any device or software that allows a user to input information, such as commands or data, into a device, or that allows the device to output information to the user. For example, the user interface includes a graphical user interface (GUI) or an interface to input computer-executable instructions that direct a processing device to carry out specific functions. The user interface typically employs certain input and output devices to input data received from a user or to output data to a user. These input and output devices may include a display, mouse, keyboard, button, touchpad, touch screen, microphone, speaker, LED, light, joystick, switch, buzzer, bell, and/or other user input/output device for communicating with one or more users.

Typically, users associated with an entity may initiate one or more communication requests (e.g., to communicate with one or more entity systems associated with the entity for performing one or more actions, to chat with a customer service agent for performing one or more actions, etc.) and such communication requests are queued up for authentication before processing the communication requests. For minimizing exposure of entity and the one or more users of the entity, it is not desirable to perform standard authentication for all type of communication requests. As such, there exists a need for a system that can efficiently and accurately select authentication tokens for authenticating users initiating one or more communication requests. The system of the present invention solves this problem as discussed in detail below.

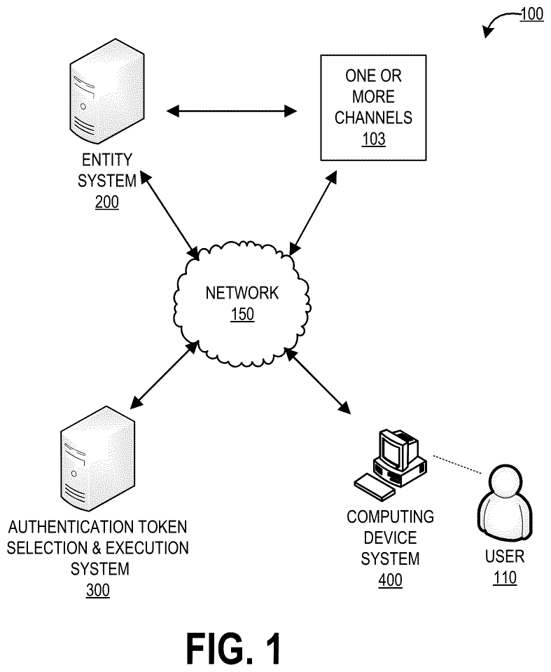

FIG. 1 provides a block diagram illustrating a system environment 100 for automatically selecting authentication tokens to authenticate users based on dynamically computed real-time exposure metrics, in accordance with an embodiment of the invention. As illustrated in FIG. 1, the environment 100 includes an authentication token selection and execution system 300, an entity system 200, one or more channels 103, and a computing device system 400. One or more users 110 may be included in the system environment 100, where the users 110 interact with the other entities of the system environment 100 via a user interface of the computing device system 400. In some embodiments, the one or more user(s) 110 of the system environment 100 may be customers of an entity associated with the entity system 200. In some embodiments, the one or more users 110 may be potential customers of the entity associated with the entity system 200. In some embodiments, the one or more users 110 may be associates (e.g., employees) of the entity associated with the entity system 200.

The entity system(s) 200 may be any system owned or otherwise controlled by an entity to support or perform one or more process steps described herein. In some embodiments, the entity may be any organization that utilizes one or more authentication methods for authenticating users communicating via one or more channels. In some embodiments, the one or more channels 103 may be a text message channel (e.g.. SMS channel), voice channel, live chat, video channel, email, and/or the like provided by the entity to the one or more users 110. In some embodiments, the entity is a financial institution. In some embodiments, the entity is a non-financial institution.

The authentication token selection and execution system 300 is a system of the present invention for performing one or more process steps described herein. In some embodiments, the authentication token selection and execution system 300 may be an independent system. In some embodiments, the authentication token selection and execution system 300 may be a part of the entity system 200. In some embodiments, the authentication token selection and execution system 300 may be controlled, owned, managed, and/or maintained by the entity associated with the entity system 200.

The authentication token selection and execution system 300, the entity system 200, and the computing device system 400 may be in network communication across the system environment 100 through the network 150. The network 150 may include a local area network (LAN), a wide area network (WAN), and/or a global area network (GAN). The network 150 may provide for wireline, wireless, or a combination of wireline and wireless communication between devices in the network. In one embodiment, the network 150 includes the Internet. In general, the authentication token selection and execution system 300 is configured to communicate information or instructions with the entity system 200, and/or the computing device system 400 across the network 150.

The computing device system 400 may be a system owned or controlled by the entity of the entity system 200 and/or the user 110. As such, the computing device system 400 may be a computing device of the user 110. In general, the computing device system 400 communicates with the user 110 via a user interface of the computing device system 400, and in turn is configured to communicate information or instructions with the authentication token selection and execution system 300, and/or entity system 200 across the network 150.

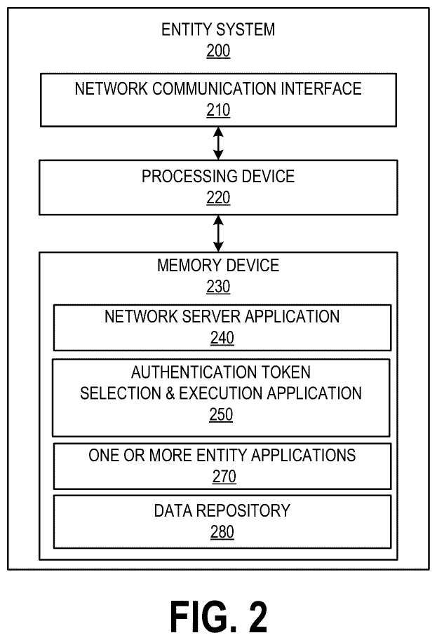

FIG. 2 provides a block diagram illustrating the entity system 200, in greater detail, in accordance with embodiments of the invention. As illustrated in FIG. 2, in one embodiment of the invention, the entity system 200 includes one or more processing devices 220 operatively coupled to a network communication interface 210 and a memory device 230. In certain embodiments, the entity system 200 is operated by a first entity, such as a financial institution or a non-financial institution.

It should be understood that the memory device 230 may include one or more databases or other data structures/repositories. The memory device 230 also includes computer-executable program code that instructs the processing device 220 to perform one or more processing functionalities described herein and also to operate the network communication interface 210 to perform certain communication functions of the entity system 200 described herein. For example, in one embodiment of the entity system 200, the memory device 230 includes, but is not limited to, an authentication token selection and execution application 250, one or more entity applications 270, and a data repository 280. The one or more entity applications 270 may be any applications developed, supported, maintained, utilized, and/or controlled by the entity. The computer-executable program code of the network server application 240, the authentication token selection and execution application 250, the one or more entity application 270 to perform certain logic, data-extraction, and data-storing functions of the entity system 200 described herein, as well as communication functions of the entity system 200.

The network server application 240, the authentication token selection and execution application 250, and the one or more entity applications 270 are configured to store data in the data repository 280 or to use the data stored in the data repository 280 when communicating through the network communication interface 210 with the authentication token selection and execution system 300, and/or the computing device system 400 to perform one or more process steps described herein. In some embodiments, the entity system 200 may receive instructions from the authentication token selection and execution system 300 via the authentication token selection and execution application 250 to perform certain operations. The authentication token selection and execution application 250 may be provided by the authentication token selection and execution system 300. The one or more entity applications 270 may be any of the applications used, created, modified, facilitated, developed, and/or managed by the entity system 200.

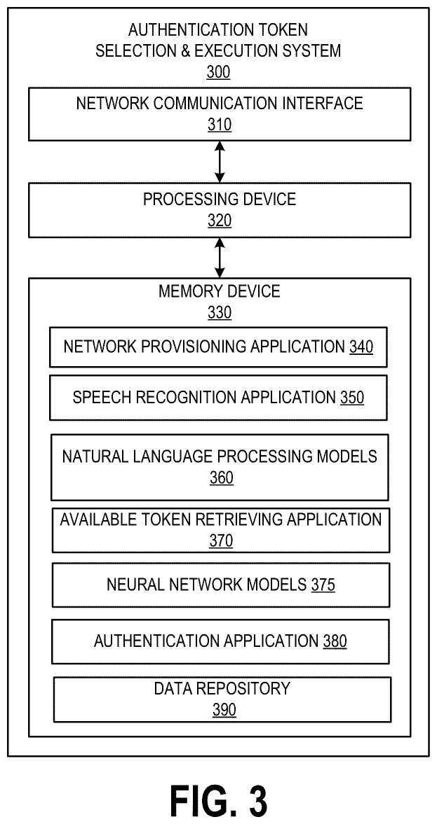

FIG. 3 provides a block diagram illustrating the authentication token selection and execution system 300 in greater detail, in accordance with embodiments of the invention. As illustrated in FIG. 3, in one embodiment of the invention, the authentication token selection and execution system 300 includes one or more processing devices 320 operatively coupled to a network communication interface 310 and a memory device 330. In certain embodiments, the authentication token selection and execution system 300 is operated by an entity, such as a financial institution. In some embodiments, the authentication token selection and execution system 300 is owned or operated by the entity of the entity system 200. In some embodiments, the authentication token selection and execution system 300 may be an independent system. In alternate embodiments, the authentication token selection and execution system 300 may be a part of the entity system 200.

It should be understood that the memory device 330 may include one or more databases or other data structures/repositories. The memory device 330 also includes computer-executable program code that instructs the processing device 320 to perform processing operations described herein and to operate the network communication interface 310 to perform certain communication functions of the authentication token selection and execution system 300. For example, in one embodiment of the authentication token selection and execution system 300, the memory device 330 includes, but is not limited to, a network provisioning application 340, a speech recognition application 350, natural language processing models 360, an available token retrieving application 370, neural network models 375, an authentication application 380, and a data repository 390 comprising any data processed or accessed by one or more applications in the memory device 330. The computer-executable program code of the network provisioning application 340, the speech recognition application 350, the natural language processing models 360, the available token retrieving application 370, the neural network models 375, and the authentication application 380 may instruct the processing device 320 to perform certain logic, data-processing, and data-storing functions of the authentication token selection and execution system 300 described herein, as well as communication functions of the authentication token selection and execution system 300.

The network provisioning application 340, the speech recognition application 350, the natural language processing models 360, the available token retrieving application 370, the neural network models 375, and the authentication application 380 are configured to invoke or use the data in the data repository 390 when communicating through the network communication interface 310 with the entity system 200, and/or the computing device system 400. In some embodiments, the network provisioning application 340, the speech recognition application 350, the natural language processing models 360, the available token retrieving application 370, the neural network models 375, and the authentication application 380 may store the data extracted or received from the entity system 200, and the computing device system 400 in the data repository 390. In some embodiments, the network provisioning application 340, the speech recognition application 350, the natural language processing models 360, the available token retrieving application 370, the neural network models 375, and the authentication application 380 may be a part of a single application (e.g., modules).

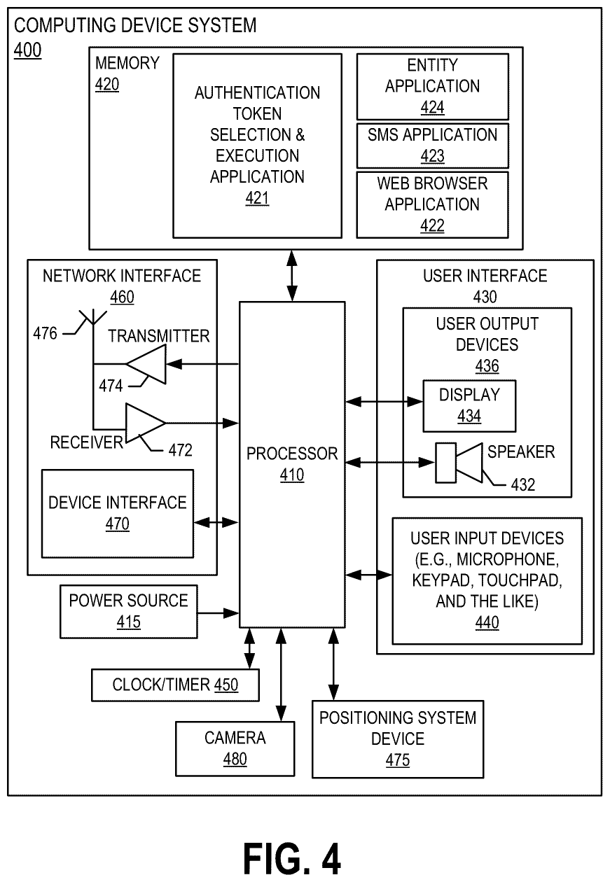

FIG. 4 provides a block diagram illustrating a computing device system 400 of FIG. 1 in more detail, in accordance with embodiments of the invention. However, it should be understood that a mobile telephone is merely illustrative of one type of computing device system 400 that may benefit from, employ, or otherwise be involved with embodiments of the present invention and, therefore, should not be taken to limit the scope of embodiments of the present invention. Other types of computing devices may include portable digital assistants (PDAs), pagers, mobile televisions, desktop computers, workstations, laptop computers, cameras, video recorders, audio/video player, radio, GPS devices, wearable devices, Internet-of-things devices, augmented reality devices, virtual reality devices, automated teller machine devices, electronic kiosk devices, or any combination of the aforementioned.

Some embodiments of the computing device system 400 include a processor 410 communicably coupled to such devices as a memory 420, user output devices 436, user input devices 440, a network interface 460, a power source 415, a clock or other timer 450, a camera 480, and a positioning system device 475. The processor 410, and other processors described herein, generally include circuitry for implementing communication and/or logic functions of the computing device system 400. For example, the processor 410 may include a digital signal processor device, a microprocessor device, and various analog to digital converters, digital to analog converters, and/or other support circuits. Control and signal processing functions of the computing device system 400 are allocated between these devices according to their respective capabilities. The processor 410 thus may also include the functionality to encode and interleave messages and data prior to modulation and transmission. The processor 410 can additionally include an internal data modem. Further, the processor 410 may include functionality to operate one or more software programs, which may be stored in the memory 420. For example, the processor 410 may be capable of operating a connectivity program, such as a web browser application 422. The web browser application 422 may then allow the computing device system 400 to transmit and receive web content, such as, for example, location-based content and/or other web page content, according to a Wireless Application Protocol (WAP), Hypertext Transfer Protocol (HTTP), and/or the like.

The processor 410 is configured to use the network interface 460 to communicate with one or more other devices on the network 150. In this regard, the network interface 460 includes an antenna 476 operatively coupled to a transmitter 474 and a receiver 472 (together a “transceiver”). The processor 410 is configured to provide signals to and receive signals from the transmitter 474 and receiver 472, respectively. The signals may include signaling information in accordance with the air interface standard of the applicable cellular system of the wireless network 152. In this regard, the computing device system 400 may be configured to operate with one or more air interface standards, communication protocols, modulation types, and access types. By way of illustration, the computing device system 400 may be configured to operate in accordance with any of a number of first, second, third, and/or fourth-generation communication protocols and/or the like.

As described above, the computing device system 400 has a user interface that is, like other user interfaces described herein, made up of user output devices 436 and/or user input devices 440. The user output devices 436 include a display 430 (e.g., a liquid crystal display or the like) and a speaker 432 or other audio device, which are operatively coupled to the processor 410.

The user input devices 440, which allow the computing device system 400 to receive data from a user such as the user 110, may include any of a number of devices allowing the computing device system 400 to receive data from the user 110, such as a keypad, keyboard, touch-screen, touchpad, microphone, mouse, joystick, other pointer device, button, soft key, and/or other input device(s). The user interface may also include a camera 480, such as a digital camera.

The computing device system 400 may also include a positioning system device 475 that is configured to be used by a positioning system to determine a location of the computing device system 400. For example, the positioning system device 475 may include a GPS transceiver. In some embodiments, the positioning system device 475 is at least partially made up of the antenna 476, transmitter 474, and receiver 472 described above. For example, in one embodiment, triangulation of cellular signals may be used to identify the approximate or exact geographical location of the computing device system 400. In other embodiments, the positioning system device 475 includes a proximity sensor or transmitter, such as an RFID tag, that can sense or be sensed by devices known to be located proximate a merchant or other location to determine that the computing device system 400 is located proximate these known devices.

The computing device system 400 further includes a power source 415, such as a battery, for powering various circuits and other devices that are used to operate the computing device system 400. Embodiments of the computing device system 400 may also include a clock or other timer 450 configured to determine and, in some cases, communicate actual or relative time to the processor 410 or one or more other devices.

The computing device system 400 also includes a memory 420 operatively coupled to the processor 410. As used herein, memory includes any computer readable medium (as defined herein below) configured to store data, code, or other information. The memory 420 may include volatile memory, such as volatile Random Access Memory (RAM) including a cache area for the temporary storage of data. The memory 420 may also include non-volatile memory, which can be embedded and/or may be removable. The non-volatile memory can additionally or alternatively include an electrically erasable programmable read-only memory (EEPROM), flash memory or the like.

The memory 420 can store any of a number of applications which comprise computer-executable instructions/code executed by the processor 410 to implement the functions of the computing device system 400 and/or one or more of the process/method steps described herein. For example, the memory 420 may include such applications as a conventional web browser application 422, an authentication token selection and execution application 421, entity application 424. These applications also typically instructions to a graphical user interface (GUI) on the display 430 that allows the user 110 to interact with the entity system 200, the authentication token selection and execution system 300, and/or other devices or systems. The memory 420 of the computing device system 400 may comprise a Short Message Service (SMS) application 423 configured to send, receive, and store data, information, communications, alerts, and the like via the wireless telephone network 152. In some embodiments, the authentication token selection and execution application 421 provided by the authentication token selection and execution system 300 allows the user 110 to access the authentication token selection and execution system 300. In some embodiments, the entity application 424 provided by the entity system 200 and the authentication token selection and execution application 421 allow the user 110 to access the functionalities provided by the authentication token selection and execution system 300 and the entity system 200.

The memory 420 can also store any of a number of pieces of information, and data, used by the computing device system 400 and the applications and devices that make up the computing device system 400 or are in communication with the computing device system 400 to implement the functions of the computing device system 400 and/or the other systems described herein.

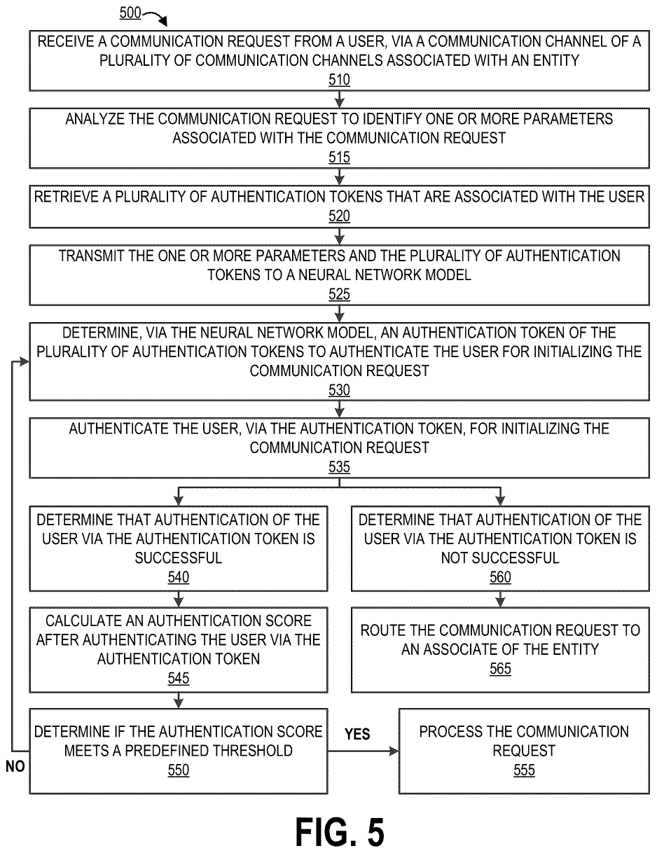

FIG. 5 provides a flowchart 500 illustrating a process flow for automatically selecting authentication tokens to authenticate users based on dynamically computed real-time exposure metrics, in accordance with an embodiment of the invention. As shown in block 510, the system receives a communication request from a user, via a communication channel of a plurality of communication channels associated with an entity. The communication request may be any type of request initiated by the user to communicate with an entity system associated with the entity or an associate (e.g., employee) of the entity. For example, an entity customer may initiate a communication request to communicate with an entity application or entity system to perform one or more actions. In another example, a user may initiate a communication request to communicate with a customer service representative to initiate a transaction. In another example, a user may initiate a communication request to communicate with a technical service representative to change or reset a password associated with an account managed by the entity. The plurality of communication channels may comprise voice channel, text channel, video channel, audio, virtual reality channel, augmented reality channel, and/or the like.

As shown in block 515, the system analyzes the communication request to identify one or more parameters associated with the communication request. The system may analyze the communication request by utilizing natural language processing models to identify the one or more parameters comprising a type of the communication request (e.g., customer service request, technical service request, and/or the like), potential actions that may be linked with the communication request (e.g., if the communication request is a technical request to a technical service representative, the potential actions may comprise changing a passcode), type of user associated with the request (e.g., preferred customer, new customer, internal employee, and/or the like associated with the entity), destination associated with the communication request (e.g., entity system, entity application, entity associate, and/or the like), and/or the like.

As shown in block 520, the system retrieves a plurality of authentication tokens for authenticating the user In some embodiments, the system may determine the plurality of authentication tokens for authenticating the user based on one or more rules, where the one or more rules may be based on historical data with the user (e.g., time of opening of an account, historical failed login attempts, recent request for an address change, recent failed authentication session with an associate of the entity, and/or the like) and real-time data collected at the time of initiation of the communication request (e.g., location, device information, carrier information, and/or the like). In some embodiments, the system may also calculate an exposure score associated with the user based on the one or more rules. The plurality of authentication tokens may comprise authentication text token, voice call authentication token, virtual reality authentication token, augmented reality authentication token, video, tokens associated with verification of personal information (date of birth, last four digits of identification number, etc.), tokens associated with verification of resource credentials (security code of a credit card, last four digits of a debit card, etc.), and/or the like.

As shown in block 525, the system transmits the one or more parameters and the plurality of authentication tokens to a neural network model. The neural network model may be a token selection neural network model that is trained using historical data associated with the one or more users (e.g., customers) and one or more associates (e.g., customer service representatives) of the entity. For example, the system may train the neural network models with historical decisions that were taken by associates to authenticate users of the entity.

As shown in block 530, the system determines, via the neural network model, an authentication token of the plurality of authentication tokens to authenticate the user for processing the communication request. The system may select an authentication token of the plurality of the authentication tokens based on at least one of the one or more parameters, the one or more rules, the exposure score, and the plurality of authentication tokens available to authenticate the user. For example, the system may determine that the communication request is to initiate a transaction and the system may select verification of security code of a credit card as a preferred authentication token to authenticate the user and process the communication request. In another example, the system may determine, based on recent failed login attempts and recent address change request, that the exposure score associated with the user and the communication request is high and may select a strong authentication token of the plurality of the authentication tokens to authenticate the user for processing the communication request.

In some embodiments, the system may calculate a first exposure score associated with the user based on the one or more rules and a second exposure score associated with the communication request based on the one or more parameters. In some embodiments, the system may use combined exposure scores of the user and the communication request to select the authentication token of the plurality of authentication tokens.

As shown in block 535, the system authenticates the user, via the authentication token, for processing the communication request. After performing authentication of the user using the authentication token, the system determines if the authentication of the user is successful or not. If the system determines that the authentication of the user is successful, the process flow proceeds to block 540. If the system determines that the authentication of the user is not successful, the process flow proceeds to block 560.

As shown in block 540, the system determines that authentication of the user via the authentication token is successful. As shown in block 545, the system calculates an authentication score after authenticating the user via the authentication token. The authentication score may be based on the strength of the authentication token used to authenticate the user. For example, authentication token associated with verification of last name may have a lower authentication score than authentication token associated with verification of last four digits of a debit card. In some embodiments, the system may assign a weight to each of the plurality of authentication tokens based on strength of the authentication tokens, where the weight may be used to calculate the authentication score. In some embodiments, the system may classify the plurality of authentication tokens into one or more tiers based on strength of the authentication tokens. In some embodiments, the system may use an artificial intelligence engine to determine strength of each of the plurality of authentication tokens. In some embodiments, the system may determine strength of each of the plurality of authentication tokens based on input from one or more employees of the entity.

As shown in block 550, the system determines if the authentication score meets a predefined threshold. In one embodiment, where the authentication score meets the predefined threshold, the process flow proceeds to block 555, where the system processes the communication request. In another embodiment, where the authentication score does not meet the predefined threshold, the process flow proceeds to block 530, where the process of selecting another authentication token for authenticating the user is repeated until the authentication score meets the predefined threshold. In some embodiments, the predefined threshold may be dynamically determined by the system based on the exposure score dynamically calculated by the system in real-time as explained in block 520. For example, if the exposure score is determined to be high based on the one or more rules, the system may assign a high predefined threshold for the authentication score. In another example, if the exposure score is determined to be low based on the one or more rules, the system may assign a low predefined threshold for the authentication score.

As shown in block 560, the system determines that authentication of the user via the authentication token is not successful. As shown in block 565, the system routes the communication request to an associate of the entity, where the associated of the entity may analyze the data associated with unsuccessful authentication of the user and perform one or more mitigation actions if needed based on the exposure score calculated by the system.

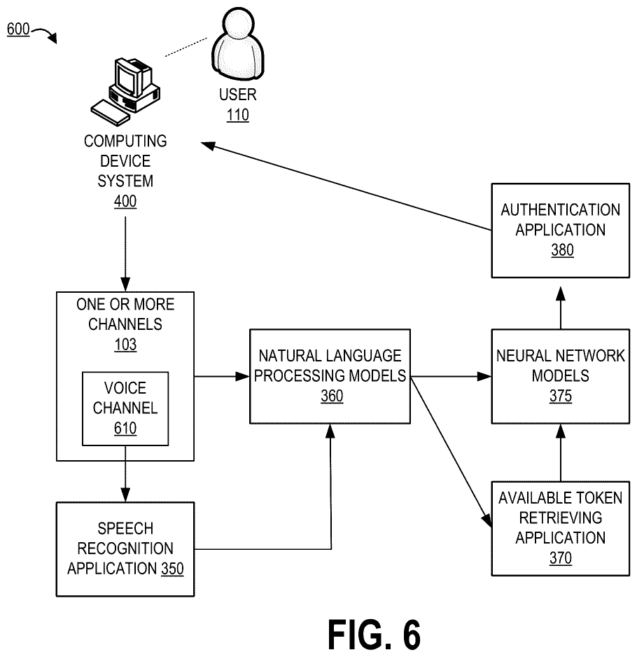

FIG. 6 provides a block diagram illustrating the process of automatically selecting authentication tokens to authenticate users based on dynamically computed real-time exposure metrics, in accordance with an embodiment of the invention. As shown, the user 110 may initiate a communication request via the one or more channels 103 provided by an entity via the computing device system 400. In one example, the user 110 may initiate the communication request via a voice channel by calling a customer service representative associated with the entity. Once the communication request is initiated via the one or more channels 103, the natural language processing models 360 may analyze the communication request to identify the one or more parameters, the one or more rules, and other information associated with the user 110. In the example, where the communication request is initiated via the voice channel, the speech recognition application 350 of the system may convert the speech to text and provide the text to the natural language processing model 360 for analyzing the communication request. The natural language processing models 360 may then transmit the one or more parameters to the neural network models 375 and the user information to the available token retrieving application 370. The available token retrieving application 370 may retrieve plurality of authentication tokens that are associated with the user from a data repository (e.g., data repository 390 or data repository 280) based on the one or more rules identified by the natural language processing models 360. The available token retrieving application 370 then transmits the retrieved plurality of authentication tokens to the neural network models 375. The available token retrieving application 370 may also calculate an exposure score based on the one or more rules, the one or more parameters, information associated with the user, information associated with the communication request, and/or the like, where the exposure score may be used to retrieve the plurality of authentication tokens, where the exposure score may also be transmitted to the neural network models 375. The neural network models 375, based on the one or more parameters, the exposure score, the one or more rules, and the plurality of authentication tokens associated with the user, selects an authentication token of the plurality of authentication tokens for authenticating the user. The authentication application 380 performs authentication of the user using the authentication token selected by the neural network models 375. This process if repeated by the neural network models 375 and the authentication application 380 until an authentication score is reached, where the authentication application 380 calculates the authentication score. If the authentication is successful, the communication request is processed and if the authentication is not successful, the communication request and the authentication token are flagged for review by an associate of the entity.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for automatically selecting authentication tokens to authenticate users based on dynamically computed real-time exposure metrics, the system comprising:
at least one network communication interface;
at least one non-transitory storage device; and
at least one processing device coupled to the at least one non-transitory storage device and the at least one network communication interface, wherein the at least one processing device is configured to:
receive a communication request from a user, via a communication channel of a plurality of communication channels associated with an entity;
analyze the communication request to identify one or more parameters associated with the communication request;
retrieve a plurality of authentication tokens that are associated with the user;
transmit the one or more parameters and the plurality of authentication tokens to a neural network model;
determine, via the neural network model, a first authentication token of the plurality of authentication tokens to authenticate the user for processing the communication request; and
authenticate the user, via the first authentication token, for processing the communication request.

2. The system of claim 1, wherein the at least one processing device is configured to:
determine that authentication of the user via the first authentication token is successful; and
process the communication request.

3. The system of claim 1, wherein the at least one processing device is configured to:
determine that authentication of the user via the first authentication token is not successful; and
route the communication request to an associate of the entity.

4. The system of claim 1, wherein the at least one processing device is configured to:
calculate an authentication score after authenticating the user via the first authentication token;
determine that the authentication score does not meet a predefined threshold; and
continue authenticating the user via the plurality of authentication tokens excluding the first authentication token until the authentication score of the user reaches the predefined threshold.

5. The system of claim 4, wherein the at least one processing device is configured to continue authenticating the user until the authentication score of the user reaches the predefined threshold based on:
determining, via the neural network model, a second authentication token of the plurality of authentication tokens; and
authenticating the user via the second authentication token.

6. The system of claim 1, wherein the at least one processing device is configured to train the neural network model based on historical communication data between one or more users and one or more associates associated with the entity.

7. The system of claim 1, wherein the communication channel is a voice communication channel.

8. The system of claim 7, wherein the at least one processing device is configured to convert voice input received from the user to text input, via one or more natural language processing models for determining the one or more parameters associated with the communication request.

9. The system of claim 1, wherein the at least one processing device is configured to determine the plurality of authentication tokens for authenticating the user based on one or more rules.

10. A computer program product for automatically selecting authentication tokens to authenticate users based on dynamically computed real-time exposure metrics, the computer program product comprising a non-transitory computer-readable storage medium having computer executable instructions for causing a computer processor to perform the steps of:
receiving a communication request from a user, via a communication channel of a plurality of communication channels associated with an entity;
analyzing the communication request to identify one or more parameters associated with the communication request;
retrieving a plurality of authentication tokens that are associated with the user;
transmitting the one or more parameters and the plurality of authentication tokens to a neural network model;
determining, via the neural network model, a first authentication token of the plurality of authentication tokens to authenticate the user for processing the communication request; and
authenticating the user, via the first authentication token, for processing the communication request.

11. The computer program product of claim 10, wherein the computer executable instructions cause the computer processor to perform the steps of:
determining that authentication of the user via the first authentication token is successful; and
processing the communication request.

12. The computer program product of claim 10, wherein the computer executable instructions cause the computer processor to perform the steps of:
determining that authentication of the user via the first authentication token is not successful; and
routing the communication request to an associate of the entity.

13. The computer program product of claim 10, wherein the computer executable instructions cause the computer processor to perform the steps of:
calculating an authentication score after authenticating the user via the first authentication token;
determining that the authentication score does not meet a predefined threshold; and
continuing to authenticate the user via the plurality of authentication tokens excluding the first authentication token until the authentication score of the user reaches the predefined threshold.

14. The computer program product of claim 13, wherein the computer executable instructions cause the computer processor to perform the steps of continuing to authenticate the user until the authentication score of the user reaches the predefined threshold based on:
determining, via the neural network model, a second authentication token of the plurality of authentication tokens; and
authenticating the user via the second authentication token.

15. The computer program product of claim 10, wherein the computer executable instructions cause the computer processor to perform the step of training the neural network model based on historical communication data between one or more users and one or more associates associated with the entity.

16. A computer implemented method for automatically selecting authentication tokens to authenticate users based on dynamically computed real-time exposure metrics, wherein the method comprises:
receiving a communication request from a user, via a communication channel of a plurality of communication channels associated with an entity;
analyzing the communication request to identify one or more parameters associated with the communication request;
retrieving a plurality of authentication tokens that are associated with the user;
transmitting the one or more parameters and the plurality of authentication tokens to a neural network model;
determining, via the neural network model, a first authentication token of the plurality of authentication tokens to authenticate the user for processing the communication request; and
authenticating the user, via the first authentication token, for processing the communication request.

17. The computer implemented method of claim 16, wherein the method comprises:
determining that authentication of the user via the first authentication token is successful; and
processing the communication request.

18. The computer implemented method of claim 16, wherein the method comprises:
determining that authentication of the user via the first authentication token is not successful; and
routing the communication request to an associate of the entity.

19. The computer implemented method of claim 16, wherein the method comprises:
calculating an authentication score after authenticating the user via the first authentication token;
determining that the authentication score does not meet a predefined threshold; and
continuing to authenticate the user via the plurality of authentication tokens excluding the first authentication token until the authentication score of the user reaches the predefined threshold.

20. The computer implemented method of claim 19, wherein continuing to authenticate the user until the authentication score of the user reaches the predefined threshold comprises:
determining, via the neural network model, a second authentication token of the plurality of authentication tokens; and
authenticating the user via the second authentication token.
